(19) United States
(12) Patent Application Publication
(10) Pub. No.: US 2026/0066642 A1
(43) Pub. Date: Mar. 5, 2026

(54) LEAKAGE PROTECTION DEVICE

(71) Applicant: Chengli LI, Suzhou (CN)

(72) Inventors: Chengli LI, Suzhou (CN); Zenghui LV, Suzhou (CN); Xiaoming ZHANG, Suzhou (CN)

(73) Assignee: Chengli LI, Suzhou (CN)

(21) Appl. No.: 18/911,925

(22) Filed: Oct. 10, 2024

(30) Foreign Application Priority Data
Aug. 28, 2024 (CN) 202411190317.6
Aug. 28, 2024 (CN) 202422095658.7

(51) Int. Cl. H02H 3/16; H01R 13/717

(52) U.S. Cl. CPC H02H 3/16; H01R 13/717

(57) ABSTRACT

A leakage protection devices for power connection includes a shell and a core assembly disposed in the shell. The core assembly includes input-end assembly, output-end assembly, actuator assembly, control circuit board, and fault detection assembly. The fault detection assembly is coupled to the control circuit board and detects one or more electrical parameters of the leakage protection device. The actuator assembly disconnects the input and out-end assemblies based on at least one detected electrical parameter exceeding a corresponding preset value, and the control circuit board prevents the input and output-end assemblies from being re-connected before the input power supply is disconnected, whereby power output at the output-end assembly is prevented. By integrating the fault detection component, the device can effectively detect and avoid danger due to various faults in the device, protecting safety and property of the user.

### BACKGROUND OF THE INVENTION

This invention relates to electrical devices and appliances, and in particular, it relates to a leakage protection device with a fault protection function and capability of providing displays of multiple states.

In order to improve the safety of electrical devices and their use, leakage protection devices are being used more widely, and their application areas and scenarios are also continuing to increase. Existing leakage protection devices can provide basic leakage protection function, so that when a current leakage is detected at the load end, the devices can quickly trip to cut off power to the load end and protect personal safety of the user. However, safety issues are still present in actual use. For example, local overheating of the leakage protection device can cause the device's shell to melt and even cause fires. In addition, existing leakage protection devices usually do not have a status indication function, or only provide an indication function to display the normal working state. Users cannot intuitively perceive the various faults occurring in the devices, which makes the devices inconvenient to use.

As consumers' requirements for the reliability and functionality of leakage protection devices continue to increase, there is a need for leakage protection devices that can provide fault protection functions and provide intuitive visual display functions for working state and fault state of the devices.

### SUMMARY OF THE INVENTION

Based on the above needs, embodiments of the present invention provide a leakage protection device which, in addition to the conventional leakage protection function, has additional fault protection functions, such as overheating detection and power cut-off to prevent the temperature from continuing to rise, and can provide different status indications based on the working state and fault state of the device, which is convenient for users to use and improves the comfort and safety of the user experience.

Accordingly, in one aspect, the present invention provides a leakage protection devices for power connection, which includes: a shell, and a core assembly disposed in the shell, including: an input-end assembly, configured to be coupled to input power supply; an output-end assembly, coupled to be coupled to an electrical load; an actuator assembly, configured to control a connection and disconnection state between the input-end assembly and the output-end assembly; a control circuit board, configured to control movement and state of the actuator assembly; and a fault detection assembly, coupled to the control circuit board, configured to detect one or more electrical parameters of the leakage protection device, wherein the actuator assembly is configured to disconnect the input-end assembly and the output-end assembly based on at least one of the electrical parameters detected by the fault detection assembly exceeding a corresponding preset value, and wherein the control circuit board is configured to prevent the input-end assembly and the output-end assembly from being re-connected before the input-end assembly is disconnected from the input power supply whereby power output at the output-end assembly is prevented.

Based on the above principles, preferred embodiments of the present invention include one or more of the following.

In some embodiments, the fault detection assembly includes at least a temperature sensor coupled to the control circuit board and disposed adjacent to the input-end assembly to detect a temperature of the input-end assembly.

In some embodiments, the fault detection assembly includes at least a current transformer coupled to the control circuit board and configured to detect a current of the output-end assembly.

In some embodiments, the fault detection assembly includes at least a resistor coupled to the control circuit board and disposed configured to detect a voltage of the input-end assembly.

In some embodiments, the core assembly further includes a reset assembly configured to reset the connection of the input-end assembly and the output-end assembly after they are disconnected.

In some embodiments, the core assembly further includes a status indicator coupled to the control circuit board to provide an indication based on one or more states of the core assembly.

In some embodiments, the one or more states of the core assembly include one or more of a connected state, a disconnected state, a current leakage detected state, an electrical fault state, and a self-test fault state.

In some embodiments, the status indicator includes an indicator light, wherein based on the state of the core assembly, the indicator light is in an off state, steadily lit states of one of multiple colors, or flashing states one of multiple colors.

In some embodiments, the indicator light is configured to be steadily lit or flashing in a first color in response to the core assembly being in an electrical fault state, or to be steadily lit in a second color in response to the core assembly being in a connected state, to be off or flashing in a second color in response to the core assembly being in a current leakage detected state, or to be steadily lit or flashing in a third color in response to the core assembly being in a self-test fault state.

In some embodiments, the shell includes at least one status indication window to permit direct observation of the one or more states of the core assembly from outside of the shell.

In some embodiments, the status indication window includes a light guide.

In some embodiments, the input-end assembly or the output-end assembly includes resilient members, wherein the resilient members cooperate with the actuator assembly to cause the input-end assembly and the output-end assembly to be separate from each other or in contact with each other to be in a disconnected state or a connected state.

In some embodiments, the actuator assembly includes a coil assembly coupled to the control circuit board, a magnetic frame assembly, a reset plate, and an iron core, wherein the coil assembly is disposed in the magnetic frame assembly and is configured to generate a magnetic field in an energized state and remove the magnetic field in a de-energized state, wherein the iron core passes through an inner hole of the coil assembly and is configured to move in response to the energized state or the de-energized state of the coil assembly.

In some embodiments, the reset plate is attached to the iron core and configured to be driven, when the coil assembly is energized, by movements of the iron core from an initial position, to cause the input-end assembly and the output-end assembly to be in contact and in a connected state, and wherein when the coil assembly is de-energized, the resilient members separate the input-end assembly from the output-end assembly into a disconnected state and drives the reset plate and the iron core to move to the initial position.

In some embodiments, the reset plate has a first end attached to the iron core and a second end adapted to abut against the resilient members, wherein the first end and the second end are configured to pivot around a pivot axis under actions of the iron core or the resilient members.

In some embodiments, the reset assembly includes a reset switch coupled to the control circuit board and a reset button attached to the reset switch, wherein the reset button is exposed outside the shell.

In some embodiments, the core assembly includes a test assembly, which includes a test switch coupled to the control circuit board and a test button attached to the test switch, where the test button is exposed outside the shell.

In some embodiments, the leakage protection device is a power plug, wherein the input-end assembly includes at least a pair of plug prongs extending out of the shell, wherein the temperature sensor is disposed on an inner wall of the shell and between the pair of plug prongs or adjacent to each plug prong.

In some embodiments, the actuator assembly is configured to disconnect the input-end assembly and the output-end assembly from each other based on a temperature detected by the temperature sensor exceeding a preset parameter, and to prevent the input-end assembly and the output-end assembly from being re-connected before the input-end assembly is disconnected from the input power supply so that the output-end assembly has no power output, and wherein after the input-end assembly is disconnected from the input power supply and then re-connected to the input power supply, the input-end assembly and the output-end assembly are re-connected by reset.

In some embodiments, the actuator assembly is configured to disconnect the input-end assembly and the output-end assembly from each other based on at least one electrical parameter detected by the fault detection assembly exceeding a corresponding preset parameter, wherein the control circuit board is configured to prevent the input-end assembly and the output-end assembly from being re-connected before the input-end assembly is disconnected from the input power supply so that the output-end assembly has no power output, and wherein after the input-end assembly is disconnected from the input power supply and then re-connected to the input power supply, the input-end assembly and the output-end assembly are re-connected by reset.

In some embodiments, the shell includes an upper shell and a lower shell attached to each other, the lower shell including a first lower shell portion and a second lower shell portion attached to each other, and wherein the leakage protection device further comprises least one sealing member disposed between the upper shell and the lower shell and/or between the first lower shell portion and the second lower shell portion.

Embodiments of the present invention integrate a fault detection component in the leakage protection device, effectively detecting and avoiding dangerous situations caused by various faults in the leakage protection device, thereby protecting the personal safety of users and the safety of their properties. Furthermore, in certain embodiments, by integrating status indicators, while providing reliability for the leakage protection device, reasonable structural design and layout are used to realize the functions of working status display and fault status display in a smaller space. The user can be provided with instructions or warnings based on the working status and fault status, thereby improving safety of use. The leakage protection device disclosed in embodiments of the present invention has a simple structure, low cost, is easy to implement, has reliable performance, is suitable for automated production, and can be applied to various occasions.

### BRIEF DESCRIPTION OF DRAWINGS

Other features and advantages of the present invention may be understood from the embodiments described below with reference to the drawings.

FIG. 1 illustrates the exterior appearance of a leakage protection device according to embodiments of the present invention.

FIG. 2 illustrates the exterior appearance of the leakage protection device of FIG. 1 from another viewing angle.

FIG. 3 illustrates the exterior appearance of the leakage protection device of FIG. 1 from yet another viewing angle.

FIG. 4 is an exploded view of the leakage protection device of FIG. 1.

FIG. 5 illustrates the shell of the leakage protection device of FIG. 1.

FIG. 6 illustrates the shell of the leakage protection device of FIG. 1 from another viewing angle.

FIG. 7 is an exploded view of the shell.

FIG. 8A is a schematic diagram showing the connection principle of each component according to an embodiment of the leakage protection device of FIG. 1.

FIG. 8B is a schematic diagram showing the connection principle of each component according to another embodiment of the leakage protection device of FIG. 1.

FIG. 9 illustrates an exemplary core assembly in the embodiment of FIG. 4.

FIG. 10 illustrates the core assembly of FIG. 9 from another viewing angle.

FIG. 11 is an exploded view of the core assembly of FIG. 10.

FIG. 12 is a cross-sectional view of the input-end assembly and the output-end assembly of the leakage protection device in a disconnected state.

FIG. 13 is a cross-sectional view of the input-end assembly and the output-end assembly of the leakage protection device in a connected state.

FIG. 14 is a circuit diagram of a leakage protection device according to an embodiment of the present invention.

### DETAILED DESCRIPTION OF THE INVENTION

Preferred embodiments of the present and their applications are described below. It should be understood that these descriptions describe embodiments of the present invention but do not limit the scope of the invention. When describing the various components, directional terms such as “up,” “down,” “top,” “bottom” etc. are not absolute but are relative. These terms may correspond to the views in the various illustrations, and can change when the views or the relative positions of the components change.

In this disclosure, terms such as “including” are intended to be open-ended and mean “including without limitation”, and can include other contents not specifically described.

In this disclosure, terms such as “connect”, “couple”, “link” etc. should be understood broadly; for example, they may be fixed connections, or removable or detachable connections, or integrally connected for integrally formed; they may be directly connected, or indirectly connected via intermediate parts. Those skilled in the relevant art can readily understand the meaning of these terms as used in this disclosure based on the specific description and context.

In this disclosure, unless specifically indicated, terms such as “first”, “second”, etc. do not connote a temporal or spatial sequence or a particular number of parts.

The core assembly (movement assembly) in conventional leakage protection device usually integrates most of the components that provide leakage protection function to provide basic leakage protection function, including but not limited to providing tripping function, resetting function, etc. When a current leakage is detected at the load end, the device can quickly trip to cut off the power to the load end to protect the personal safety of the user. However, the inventors of this invention found that during actual use, local overheating of the leakage protection device can cause the device shell to melt and even cause fires. For example, for power plugs with leakage protection function, at the connection point between the plug prongs and the socket holes, in some cases, the resilience of the prongs inside the socket may decrease, resulting in an increase in local contact resistance at the contact points, which in turn causes local overheating of the plug prongs which can ultimately melt the plug shell and even causes fires. In addition, the inventors found that conventional leakage protection devices usually do not have a status indication function, or only provide an indication function to display the normal working state. Users cannot have an intuitive perception of the various faults occurring in the device or on the power lines, which is inconvenient to use and also increases the risk of unsafe use of electrical devices and compliances.

Based on the above, embodiments of the invention provide a leakage protection device, which can effectively detect fault conditions and provide fault protection, such as detecting the overheating state of the input-end assembly, and can quickly cut off the power supply after the overheating state is detected, thereby avoiding dangerous situations caused by overheating of the input-end assembly. This avoids the occurrence of electrical fires in addition to avoiding leakage accidents, thereby protecting the personal safety of users and the safety of their properties.

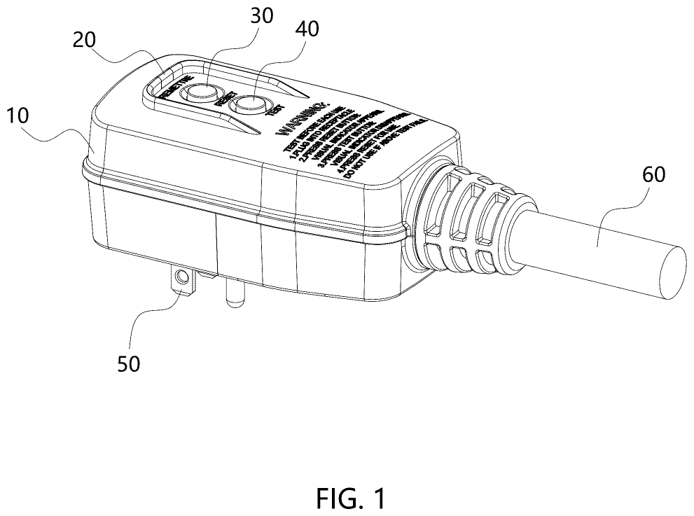

FIG. 1 shows an exemplary leakage protection device in the form of a power plug with leakage protection functions. It should be understood that while a power plug with leakage protection function is used as an example, leakage protection devices within the scope of the present invention include but are not limited to power plugs with leakage protection and power receptables with leakage protection.

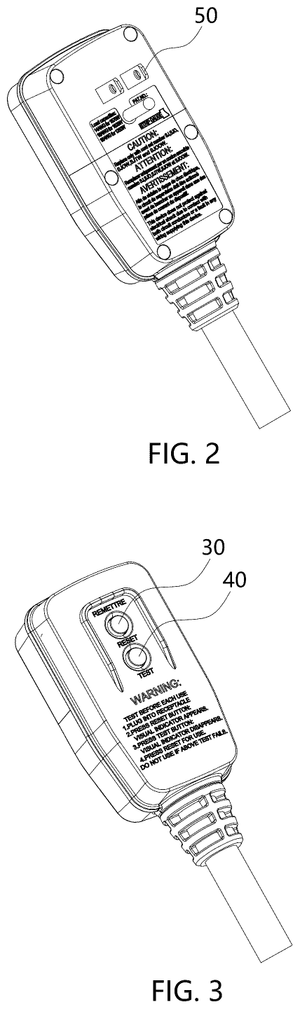

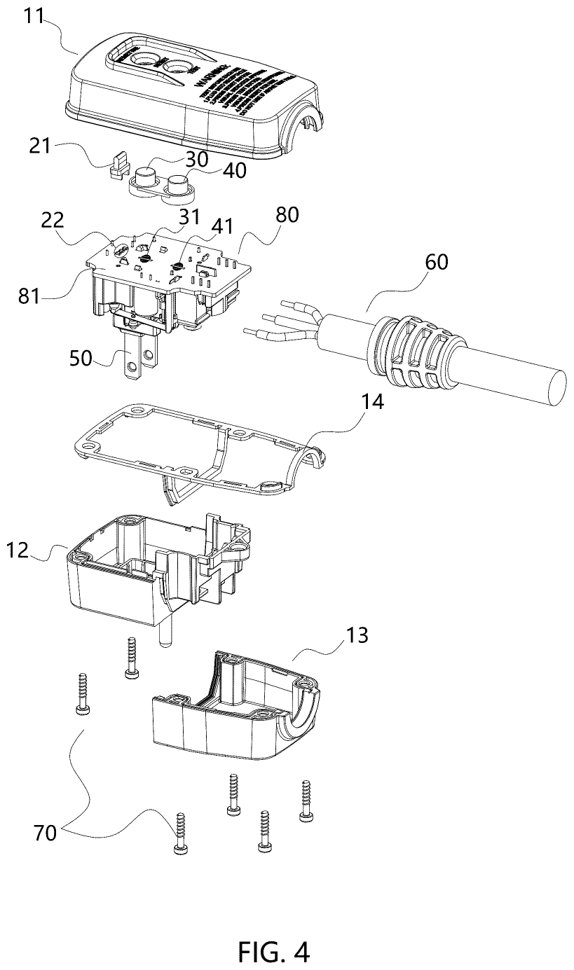

Referring to FIGS. 1 to 4, a leakage protection device according to embodiments of the present invention includes a shell (also referred to as a housing) 10 and a core assembly (also referred to as a movement assembly) 80 disposed in the shell 10. The core assembly 80 includes a control circuit board 81, an input-end assembly and an output-end assembly coupled to the control circuit board 81, and an actuator assembly. Here, the actuator assembly refers to an assembly that is controlled by the control circuit board 81 and can manipulate the connection state (that is, disconnected (open) or connected (closed) states) between the input-end assembly and the output-end assembly. In the illustrated embodiment, the core assembly 80 further includes a reset assembly, which is configured to reset the connection of the input-end assembly and the output-end assembly after they are disconnected. The reset assembly includes a reset switch 31 coupled to the control circuit board 81 and a reset button 30 attached to the reset switch 31. The reset button 30 may be exposed outside the shell 10. More specifically, referring to FIGS. 4 to 7, the shell 10 may include an upper shell 11 and a lower shell attached to each other, the lower shell including a first lower shell portion 12 and a second lower shell portion 13 attached to each other. The upper shell 11 defines a reset button opening 112 for the reset button 30 to protrude from the upper shell 11.

Preferably, the core assembly 80 includes a test assembly, which includes a test switch 41 coupled to the control circuit board 81 and a test button 40 attached to the test switch 41, where the test button 40 may be exposed outside the shell 10. More specifically, the upper shell 11 defines a test button opening 113 for the test button 40 to protrude from the upper shell 11.

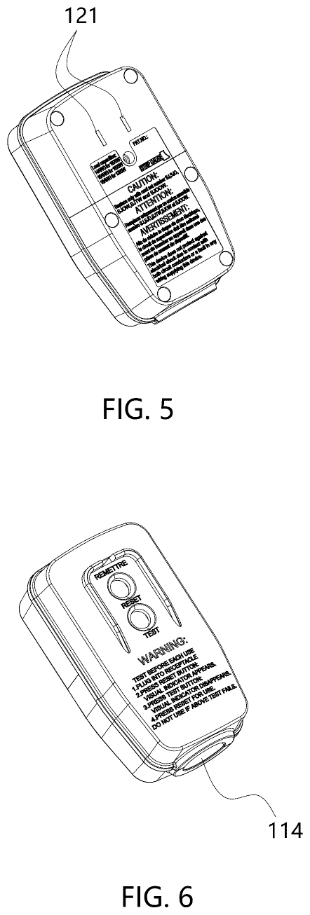

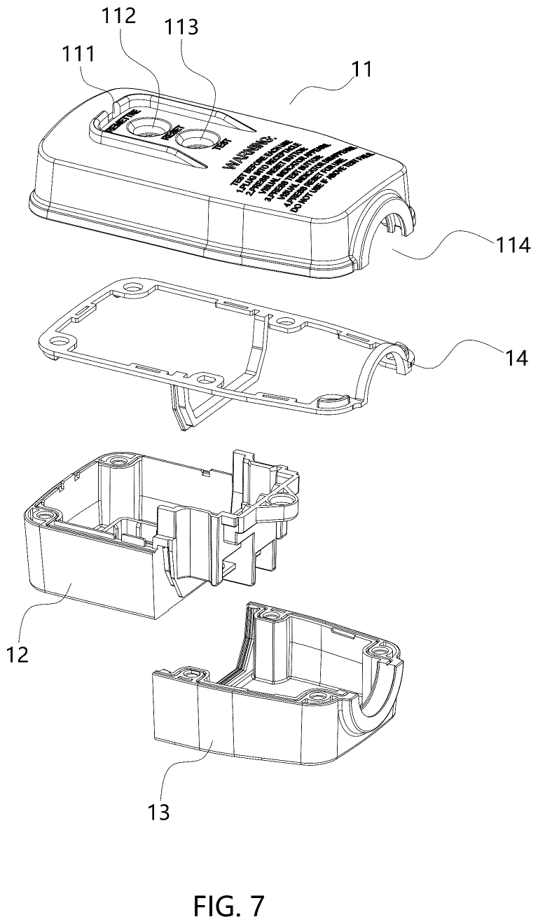

The input-end assembly includes at least a pair of plug prongs 50 extending out of the shell 10, and the output-end assembly includes at least an output power line 60 extending out of the shell 10. Correspondingly, the shell 10 (specifically the first lower shell portion 12) may be provided with plug prong through holes 121 for the plug prongs 50 to extend out, as shown in FIG. 5, and the shell 10 may be provided with an output line through hole 114 for the output power line 60 to extend out. Specifically, the upper shell 11 and the second lower shell portion 13 may be provided with half holes respectively which jointly form an output line through hole 114, as shown in FIG. 7.

The upper shell 11 and the lower shell (the first and second lower shell portions 12 and 13) may be attached by various suitable assembly methods, including but not limited to assembly with self-tapping screws, ultrasonic welding, adhesive bonding, and the like. For example, as illustrated in FIG. 4, the upper shell 11 and the lower shell portion may be attached by screws 70. Preferably, the leakage protection device includes at least one sealing member disposed between the upper shell 11 and the lower shell and/or between the first lower shell portion 12 and the second lower shell portion 13, so that the shell has good dustproof and waterproof effects. As shown in FIGS. 4 and 7, the seal may be configured as an integral seal ring 14.

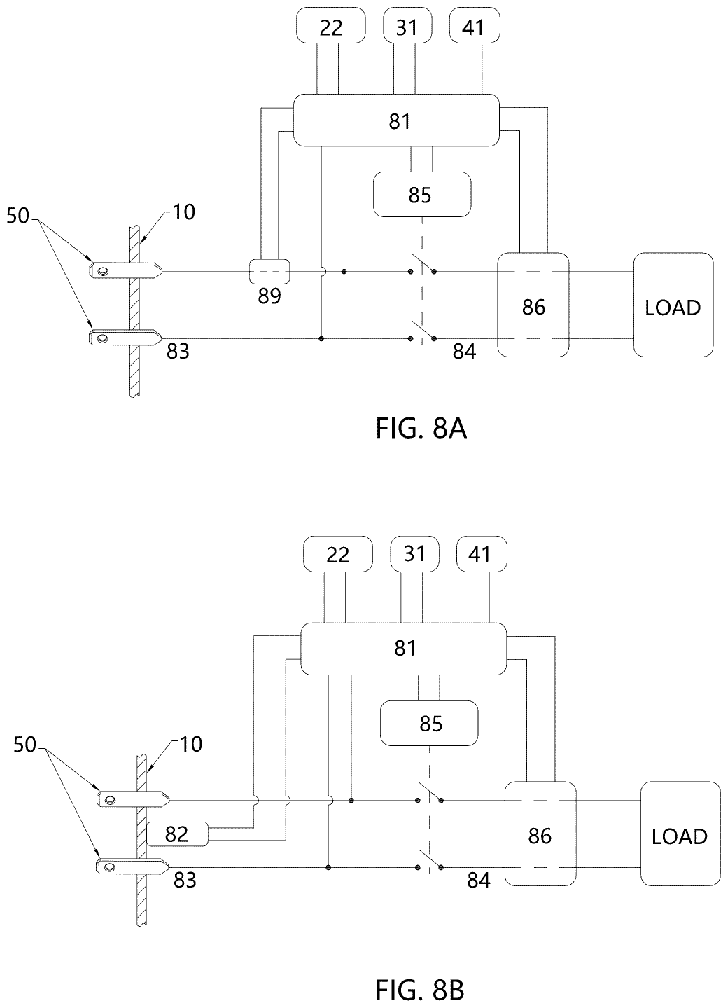

According to this embodiment, as shown in FIG. 8A, the core assembly 80 includes a fault detection assembly 89, which is coupled to the control circuit board 81 for detecting electrical parameters of the leakage protection device. The actuator assembly 85 is configured to disconnect the input-end assembly and the output-end assembly from each other based on at least one electrical parameter detected by the fault detection assembly 89 exceeding a corresponding preset parameter, and the control circuit board 81 is configured to prevent the input-end assembly and the output-end assembly from being re-connected before the input-end power is disconnected, so that the output-end assembly has no power output.

Depending on different needs, the fault detection assembly 89 includes at least a temperature sensor 82, which is coupled to the control circuit board 81 and disposed adjacent to the input-end assembly to detect the temperature of the input-end assembly. Preferably or in addition, the fault detection assembly 89 includes at least a current transformer, which is coupled to the control circuit board for detecting the current of the output-end assembly. Based on the detected current of the output-end assembly being greater than a preset current, the actuator assembly 85 causes the input-end assembly and the output-end assembly to be in a disconnected state. Alternatively, preferably or in addition, the fault detection assembly 89 includes at least a resistor on the control circuit board for detecting the voltage of the input-end assembly. Based on the detected voltage of the input-end assembly being greater than the preset voltage, the actuator assembly 85 causes the input-end assembly and the output-end assembly to be in a disconnected state. In any case, the control circuit board 81 is configured to prevent the input-end assembly and the output-end assembly from being re-connected before the input power supply to the device is disconnected, so that the output-end assembly has no power output.

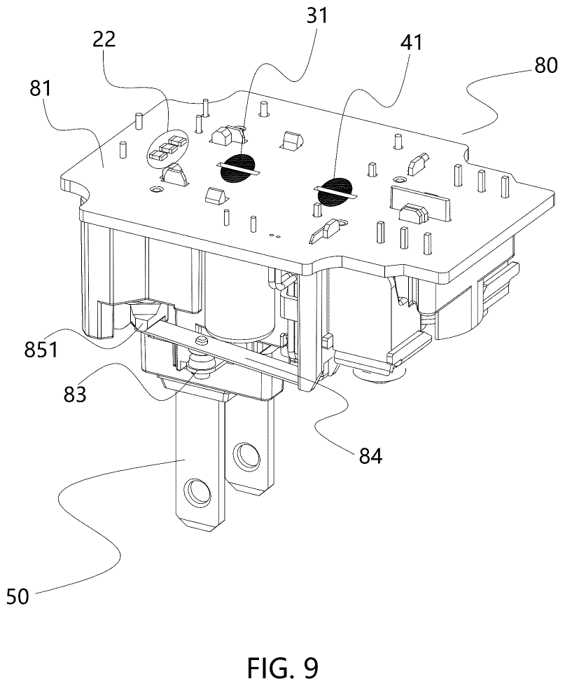

In the embodiment shown in FIG. 8B, a temperature sensor 82 is shown. The temperature sensor 82 is coupled to the control circuit board 81 and disposed adjacent to the input-end assembly to detect the temperature of the input-end assembly. In the illustrated embodiment, as shown in conjunction with FIGS. 8B to 11, the temperature sensor 82 is disposed adjacent to the input-end assembly. The core assembly 80 is configured to disconnect the input-end assembly and the output-end assembly from each other based on the temperature detected by the temperature sensor 82 being greater than a preset temperature.

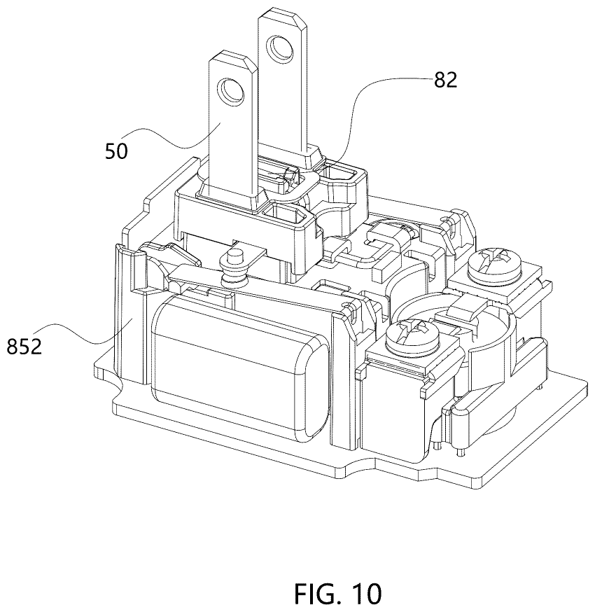

When the leakage protection device is a leakage protection plug or a leakage protection receptacle, its normal operating temperature range is usually 0° C. to 40° C. Depending on the shell material, the shell's heat resistance temperature is usually 50° C. to 70° C. Even if the heat-resistant temperature of the shell made of some materials can reach 110° C. or even 150° C., it is necessary to control the temperature of the leakage protection device to below 70° C., for example, to avoid damage to internal components. Therefore, depending on different needs, the preset temperature can be set to 70° C. to 150° C., such as 70° C., 150° C., and any temperature between the above two values, such as 75° C., 120° C., etc. Correspondingly, once the temperature sensor detects that the temperature of the input-end assembly reaches or exceeds the preset temperature, the core assembly can cause the input-end assembly and the output-end assembly to be in a disconnected state, that is, an overheating disconnection state. Preferably, for the leakage protection plug, the temperature sensor 82 can be disposed on the inner wall of the shell 10 and between the pair of plug prongs 50, as shown in FIG. 10, or disposed adjacent to each plug prong in a pair of plug prongs 50, so as to detect the temperature near the plug prongs or the temperature of the inner wall of the shell at that position, and transmit the detected temperature value signal to the control circuit board 81.

In this way, by integrating the fault detection component, the leakage protection device not only has the leakage protection function, but also has the function of quickly cutting off the power of the leakage protection device when overheating or other fault conditions are detected. For example, when the plug prong temperature or the shell temperature reaches a preset temperature value, the power supply can be quickly cut off, thereby preventing the plug prong temperature from continuing to rise and causing a dangerous situation. It should be understood that based on different needs, the number of temperature sensor can be set to one or more. When one temperature sensor is used, one or more sensing terminals can also be used to ensure the accuracy and reliability of the detected temperature value.

Preferably, the core assembly 80 is configured such that, after the device is tripped due to a fault such as overheating, before the input end is disconnected from and then reconnected to the input power supply, core assembly 80 controls the circuit board 81 to prevent the input-end assembly and the output-end assembly from being re-connected (i.e. reset). In other words, if the leakage protection device is in a tripped state (the input-end assembly and the output-end assembly are disconnected) because at least one electrical parameter detected by the fault detection component exceeds a corresponding preset parameter, the control circuit board prevents the input-end assembly and the output-end assembly from being re-connected (reset) before the input power supply is disconnected, so that the output end has no power output; that is, the input power supply to the input-end assembly needs to be disconnected and then re-connected, and the input-end assembly and the output-end assembly can then be re-connected (reset). More specifically, for example, when the temperature detected by the temperature sensor 82 is greater than the preset temperature and the input-end assembly and the output-end assembly are in a disconnected state (tripped), the input-end assembly and the output-end assembly cannot be re-connected through a conventional reset operation. The leakage protection device must be powered off (e.g. by the user disconnecting the input power supply or pulling the plug out of the socket) and then powered on again. After the user checks and confirms the fault condition (such as overheating damage), and turns on the input power supply or inserts the plug into the socket to power on the input, the leakage protection device can then return to a normal state. At this time, a reset operation can be performed (i.e. by the user pressing the reset button) to connect the input-end assembly and the output-end assembly to each other again. This further ensures the safety of the leakage protection device.

According to embodiments of the present invention, the core assembly 80 also includes a status indicator 22, which provides working state and fault state indications to indicate to the user the cause of the fault. As shown in FIG. 4, the status indicator 22 is coupled to the control circuit board 81 and can inform or warn the user based on the state of the core assembly 80. At least one status indication window 20 may be provided on the shell 10 (specifically, the upper shell portion 11), as shown in FIG. 1. The status indication window 20 may be made of a transparent material. Optionally, a status indication hole 111 may also be provided on the shell 10, as shown in FIG. 7, so that the user can directly observe one or more states of the core assembly from the outside of the shell 10. The states of the core assembly 80 include but are not limited to one or more of a connected state, a disconnected state, a current leakage detected state, an electrical fault state (such as an overheating state), and a self-test fault state. In some embodiments, the status indication window 20 (or the status indication hole 111) may be provided with a light guide 21, as shown in FIG. 4.

The status indicator 22 may be an indicator light, such as a controllable three primary colors (RGB) LED or a plurality of color LEDs. Based on the state of the core assembly 80, the indicator light may be in an off state, steadily lit states of various different colors, or flashing states of various colors. In some embodiments, based on different states of the core assembly, the indicator light is configured to be steadily lit or flashing in a first color (e.g., yellow) in response to the core assembly being in an electrical fault state (e.g., disconnection due to overheating); or the indicator light is configured to be steadily lit in a second color (e.g., green) in response to the core assembly being in a connected state; or the indicator light is configured to be off or flashing in a second color in response to the core assembly being in a current leakage detected state; or the indicator light is configured to be steadily lit or flashing in a third color (e.g., red) in response to the core assembly being in a self-test fault state.

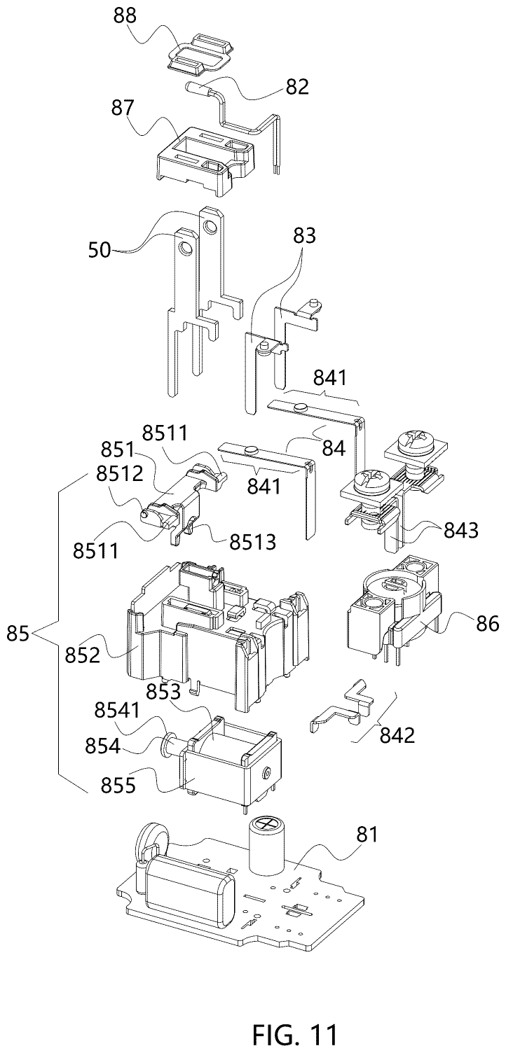

The electrical connection between the input-end assembly and the output-end assembly is achieved, for example, using movable and stationary contact plates. As shown in FIG. 11, the input-end assembly further includes a pair of input stationary contact plates 83 having stationary contact terminals (hot line input end and neutral line input end). The pair of input stationary contact plates 83 are connected to the pair of prongs 50 and are soldered to the control circuit board 81. The output-end assembly further includes a pair of output movable contact plates 84 (hot line output end and neutral line output end), wherein one end of each output movable contact plates 84 is soldered to the control circuit board 81, and the other end includes a resilient member, that is, a resilient movable contact arm 841. Each resilient movable contact arm 841 has a movable electric contact terminal and can cooperate with the actuator so that the input-end assembly and the output-end assembly are either separated from each other or are in contact with each other (that is, the stationary contacts and the movable contacts are either separated from each other or be in contact with each other) to be in either a disconnected state or a connected state. The output-end assembly further includes a pair of output terminals 843 coupled to the control circuit board 81 and a pair of output connecting plates 842 for connecting to the output power line 60. The insertion pins of the output terminals 843 pass through the center hole of the leakage detection coil 86 and are connected to one end of the respective output connecting plates 842. The other end of the output connecting plates 842 are connected to the pins of the output movable contact plate 84, so that the leakage detection coil 86 can detect the leakage signal of the main electrical circuit and transmit the signal to the control circuit board 81. In some embodiments, the input-end assembly may further include a plug prong pressing block 87 and a plug prong waterproof pad 88 disposed between the plug prong pressing block 87 and the inner wall of the shell.

In the illustrated embodiment, the core assembly 80 can be positioned and assembled in the shell 10 via a mounting bracket 852. The actuator assembly 85 includes a coil assembly 853 coupled to the control circuit board 81, a magnetic frame assembly 855 and an iron core 854. The coil assembly 853 has a coil winding and is placed in the magnetic frame assembly 855, and can generate a magnetic field in an energized state and remove the magnetic field in a de-energized state. The iron core 854 passes through the inner hole of the coil assembly 853 and is configured to move in response to the energized state or the de-energized state of the coil assembly 853. The actuator assembly may include a reset plate 851, which is attached to the iron core 854 so that when the coil assembly 853 is energized, the reset plate 851 is driven by the movement of the iron core 854 from an initial position so that the input-end assembly and the output-end assembly are in contact and in a connected state, and when the coil assembly 853 is de-energized, the resilient members (resilient movable contact arms 841) separate the input-end assembly from the output-end assembly so that they are in a disconnected state and drives the reset plate 851 and the iron core 854 to move to the initial position.

Specifically, in the illustrated embodiment, the reset plate 851 has a first end 8513 attached to the iron core 854 and a second end 8511 adapted to abut against the resilient members (resilient movable contact arms 841). Preferably, the reset plate 851 is configured to allow the first end 8513 and the second end 8511 to pivot around the pivot axis 8512 under the action of the iron core 854 or the resilient members. In this way, the compact structural design can realize the connection and disconnection of the movable contact terminals and the stationary contact terminals in a relatively small space, effectively ensuring a relatively stable connection state and disconnection state between the input-end assembly and the output-end assembly.

The state and operation process of the leakage protection device according to some embodiments of the present invention are described below with reference to FIGS. 4, 8, and 11 to 13.

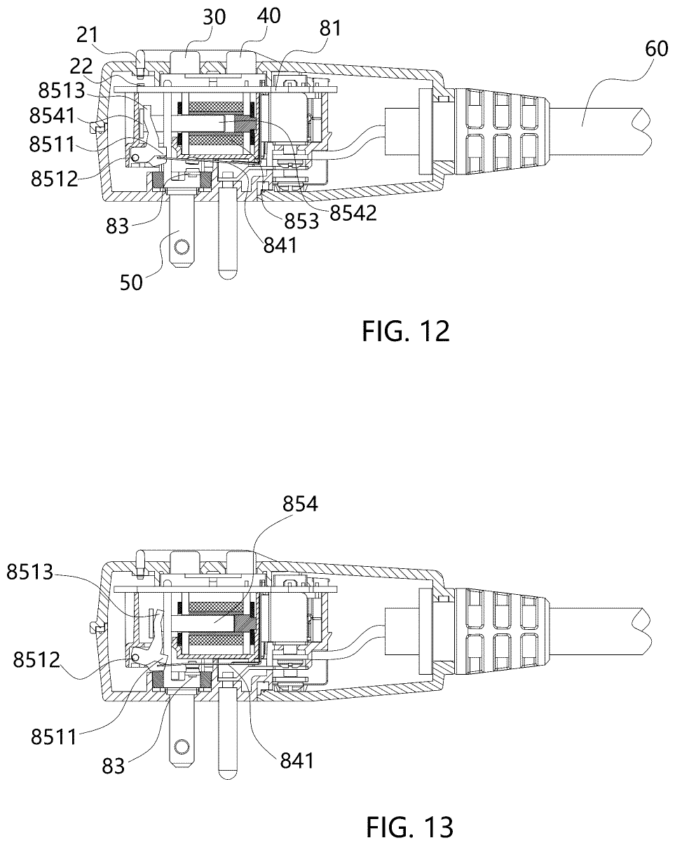

The leakage protection device shown in FIG. 12 is in a disconnected state, where the disconnected state includes but is not limited to a normal disconnected state, a leakage disconnected state (caused by tripping in response to a leakage being detected) or an overheating disconnected state (caused by tripping in response to an overheating condition being detected). At this time, the input-end assembly and the output-end assembly are disconnected, the output end or the output power line 60 has no power, and the status indicator 22 may be off.

When the device is removed from the input power supply (e.g., unplugged from the socket) and it is confirmed that the leakage protection device can be used normally again, for example, after being in the overheating disconnected state, the device is reconnected to the input power supply (e.g. the plug prongs 50 are inserted back into the power socket) to power on which enables the actuator assembly 85 to start executing the controlled reset. According to the configuration of the control circuit board 81, the controlled reset may be either an automatic reset type or a manual reset type. For the automatic reset type, when the plug prongs 50 are energized, the control circuit board 81 controls the actuator assembly 85 to act, so that the input-end assembly and the output-end assembly are in a connected state directly (i.e. without manual operation). For the manual reset type, the control circuit board 81 will control the actuator assembly 85 to connect the input-end assembly and the output-end assembly only when it receives the reset signal from the reset switch 31 (that is, the reset button 30 being manually pressed). At this time, the coil winding of the coil assembly 853 is energized to generate a magnetic field and drive the iron core 854 to move toward the interior of the coil assembly 853. Because the head 8541 of the iron core 854 is attached to the first end 8513 of the reset plate 851 (for example, clamped), when the iron core 854 moves toward the interior of the coil assembly 853, its head 8541 pulls the first end 8513 of the reset plate 851 to move together, so that the first end 8513 rotates around the pivot shaft 8512, thereby driving the reset plate 851 to abut the second end 8511 of the resilient members (resilient movable contact arms 841) to overcome the rebound force of the resilient movable contact arms 841 of the output movable contact plates 84, so that the resilient movable contact arms 841 move toward the positions of the input stationary contact plates 83 and contact and connect with the corresponding stationary contact terminals thereon, as shown in FIG. 13. This achieves the connection and conduction between the input-end assembly and the output-end assembly, and the device can work normally. At this time, the status indicator 22 may be in a green lighted state.

Conversely, when a power-off occurs and the coil winding is de-energized, the magnetic field disappears, and the output movable contact plates 84 move to a position away from the input stationary contact plates 83 under the action of the rebound force of the resilient movable contact arms 841. This disconnects the input-end assembly and the output-end assembly, while driving the reset plate 851 and the iron core 854 back to the initial position shown in FIG. 12. The status indicator 22 can be in an off state at this time.

When the leakage protection device is in a normal power-on state, and the test button 40 is pressed, the control circuit board 81 receives the test signal from the test switch 41 and provides a simulated leakage signal to the leakage detection coil 86 to test whether the leakage protection functions are intact. At this time, if the device's protection functions are intact, it will trip, that is, the actuator assembly 85 will perform the tripping action to disconnect the input-end assembly and the output-end assembly, and the status indicator 22 will be off. When the reset button 30 is pressed again, the control circuit board 81 receives the reset signal from the reset switch 31 and controls the actuator assembly 85 to cause the input-end assembly and the output-end assembly to be connected, so that the leakage protection device returns to the normal power-on state, the status indicator 22 is green and steadily lit, and the load end LOAD can receive power normally.

When the leakage protection device is in the normal power-on state, if a leakage fault occurs at the output end, the leakage detection coil 86 will send a detected leakage signal to the control circuit board 81, which then controls the actuator assembly 85 to quickly disconnect the input-end assembly and the output-end assembly to disconnect power to the output end, and the status indicator 22 will be off or flashing green.

When the leakage protection device is in the normal power-on state, if a self-test fault occurs, that is, the devices detects that some key components of the leakage protection function have failed and the device no longer has the leakage protection function, the control circuit board 81 will control the actuator assembly 85 to disconnect the input-end assembly and the output-end assembly to disconnect power to the output end, and the status indicator 22 will flash red, indicating the end of life of the device, warning the user not to continue using it.

When the leakage protection device is in the normal power-on state, if a local overheating fault occurs at the input end, the temperature sensor 82 disposed on the inner wall of the shell 10 and adjacent to the plug prongs 50 will send the detected temperature value signal to the control circuit board 81. When the control circuit board 81 determines that the received temperature value exceeds the preset temperature value, it will control the actuator assembly 85 to quickly disconnect the input-end assembly and the output-end assembly to disconnect power to the output end, so as to prevent the temperature near the plug prongs 50 of the input-end assembly from continuing to rise. At this time, the status indicator 22 is in a yellow steadily lit or flashing state, which serves as a warning. In this state, if the reset button is pressed, the actuator assembly 85 will not act, and the display state of the status indicator 22 will remain unchanged. The device will only return to its original state after being unplugged from the socket (turning off power), checked for overheating and damage, and then plugged back into the socket to turn on the power. Afterwards, the reset button 30 may be pressed to connect the input terminal component and the output terminal component, and the status indicator 22 will be green and steadily lit, indicating that the device can be used normally.

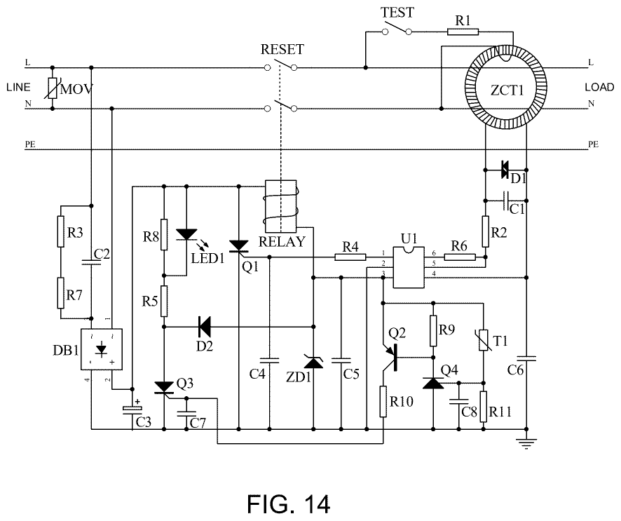

FIG. 14 is an exemplary circuit diagram of a leakage protection device according to an embodiment of the present invention. In this diagram, the leakage detection ring ZCT1 corresponds to the leakage detection coil 86; the test switch TEST and reset switch RESET respectively correspond to the switches 41 and 31; the relay coil RELAY corresponds to the coil assembly 853, the iron core 854 and the magnetic frame assembly 855; and the thermistor T1 corresponds to the temperature sensor 82. U1 is a signal processing and control circuit which includes a processing chip; DB1 is a diode bridge. The other electrical components and their connections are self-explanatory. The operation of this circuit is described below.

During normal operation, the current flows through the path L-C2-DB1-RELAY-U1-GND-DB1-N, so that the RELAY coil has a relatively large magnetic field, which maintains the RESET switch closed, and the input end LINE and output end LOAD are electrically connected. When the leakage detection coil ZCT1 detects a leakage current on the current-carrying lines L and N, it generates a leakage signal, which is input to the leakage detection chip U1 and processed there. When the leakage signal exceeds a preset threshold, pin 1 of the leakage detection chip U1 outputs a high voltage level, triggering the silicon-controlled rectifier (thyristor) Q1 to become conductive. Because of this, most of the current no longer flows through RELAY-U1-GND, but flows directly through Q1-GND. As a result, the magnetic field in the RELAY coil is weaker, causing the RESET switch to disconnect the electrical connection between the input and output ends.

When the thermistor T1 detects a relatively high temperature, its resistance decreases, and the reference pin voltage of Zener diode Q4 (i.e. the upper end of R11) rises. When this voltage is higher than the regulated voltage value of Q4 (e.g., 2.5V), Zener diode Q4 becomes conductive, which in turn triggers transistor Q2 to output a large current. The current flowing through Q2-R10 generates a voltage that triggers the silicon-controlled rectifier (thyristor) Q3 to become conductive and remain conductive. As a result, part of the current no longer flows through RELAY-U1-GND, but through LED1-R5-Q3-GND. The magnetic field of the RELAY coil becomes weaker, causing the RESET switch to disconnect the electrical connection between the input and output ends. Because the silicon-controlled rectifier Q3 remains conductive, the magnetic field in the RELAY coil remains relatively weak, which cannot keep the RESET switch in the closed state. Therefore, the device cannot be reset even when the reset button is pressed. At this time, if the input power to the device is disconnected, the silicon-controlled rectifier Q3 is turned off, and then the input power is turned on again, Q3 will remain off and the current will flow through RELAY-U1-GND again. This returns the device to the normal operating state, i.e., the RELAY coil generates a relatively large magnetic field, maintaining the RESET switch closed, so as to establish electrical connection between the input and output ends. This achieves the protection function described earlier, i.e., after a trip caused by overheating, the device must be disconnected from and then reconnected to the input power supply, before it can return to normal operation.

The leakage protection device according to embodiments of the present invention realizes multiple fault protections in a relatively small space by utilizing efficient structural design and layout, and provides the functions of working state display and fault state display, thereby effectively improving user comfort experience and safety.

It should be understood that the embodiments shown in the drawings only illustrate the preferred shapes, sizes and spatial arrangements of the various components of the leakage protection device. These illustrations do not limit the scope of the invention; other shapes, sizes and spatial arrangements may be used without departing from the spirit of the invention.

It will be apparent to those skilled in the art that various modification and variations can be made in the embodiments of the present invention without departing from the spirit or scope of the invention. Thus, it is intended that the present invention cover modifications and variations that come within the scope of the appended claims and their equivalents.

1. A leakage protection devices for power connection, comprising:
a shell; and
a core assembly disposed in the shell, including:
an input-end assembly, configured to be coupled to input power supply;
an output-end assembly, coupled to be coupled to an electrical load;
an actuator assembly, configured to control a connection and disconnection state between the input-end assembly and the output-end assembly;
a control circuit board, configured to control movement and state of the actuator assembly; and
a fault detection assembly, coupled to the control circuit board, configured to detect one or more electrical parameters of the leakage protection device,
wherein the actuator assembly is configured to disconnect the input-end assembly and the output-end assembly based on at least one of the electrical parameters detected by the fault detection assembly exceeding a corresponding preset value, and wherein the control circuit board is configured to prevent the input-end assembly and the output-end assembly from being re-connected before the input-end assembly is disconnected from the input power supply whereby power output at the output-end assembly is prevented.

2. The leakage protection device of claim 1, wherein the fault detection assembly includes at least a temperature sensor coupled to the control circuit board and disposed adjacent to the input-end assembly to detect a temperature of the input-end assembly.

3. The leakage protection device of claim 1, wherein the fault detection assembly includes at least a current transformer coupled to the control circuit board and configured to detect a current of the output-end assembly.

4. The leakage protection device of claim 1, wherein the fault detection assembly includes at least a resistor coupled to the control circuit board and disposed configured to detect a voltage of the input-end assembly.

5. The leakage protection device of claim 1, wherein the core assembly further includes a reset assembly configured to reset the connection of the input-end assembly and the output-end assembly after they are disconnected.

6. The leakage protection device of claim 1, wherein the core assembly further includes a status indicator coupled to the control circuit board to provide an indication based on one or more states of the core assembly.

7. The leakage protection device of claim 6, wherein the one or more states of the core assembly include one or more of a connected state, a disconnected state, a current leakage detected state, an electrical fault state, and a self-test fault state.

8. The leakage protection device of claim 7, wherein the status indicator includes an indicator light, wherein based on the state of the core assembly, the indicator light is in an off state, steadily lit states of one of multiple colors, or flashing states one of multiple colors.

9. The leakage protection device of claim 8, wherein the indicator light is configured to be steadily lit or flashing in a first color in response to the core assembly being in an electrical fault state,
or to be steadily lit in a second color in response to the core assembly being in a connected state, to be off or flashing in a second color in response to the core assembly being in a current leakage detected state,
or to be steadily lit or flashing in a third color in response to the core assembly being in a self-test fault state.

10. The leakage protection device of claim 6, wherein the shell includes at least one status indication window to permit direct observation of the one or more states of the core assembly from outside of the shell.

11. The leakage protection device of claim 10, wherein the status indication window includes a light guide.

12. The leakage protection device of claim 1, wherein the input-end assembly or the output-end assembly includes resilient members, wherein the resilient members cooperate with the actuator assembly to cause the input-end assembly and the output-end assembly to be separate from each other or in contact with each other to be in a disconnected state or a connected state.

13. The leakage protection device of claim 12, wherein the actuator assembly includes a coil assembly coupled to the control circuit board, a magnetic frame assembly, a reset plate, and an iron core, wherein the coil assembly is disposed in the magnetic frame assembly and is configured to generate a magnetic field in an energized state and remove the magnetic field in a de-energized state, wherein the iron core passes through an inner hole of the coil assembly and is configured to move in response to the energized state or the de-energized state of the coil assembly.

14. The leakage protection device of claim 13, wherein the reset plate is attached to the iron core and configured to be driven, when the coil assembly is energized, by movements of the iron core from an initial position, to cause the input-end assembly and the output-end assembly to be in contact and in a connected state, and wherein when the coil assembly is de-energized, the resilient members separate the input-end assembly from the output-end assembly into a disconnected state and drives the reset plate and the iron core to move to the initial position.

15. The leakage protection device of claim 14, wherein the reset plate has a first end attached to the iron core and a second end adapted to abut against the resilient members, wherein the first end and the second end are configured to pivot around a pivot axis under actions of the iron core or the resilient members.

16. The leakage protection device of claim 15, wherein the reset assembly includes a reset switch coupled to the control circuit board and a reset button attached to the reset switch, wherein the reset button is exposed outside the shell.

17. The leakage protection device of claim 1, wherein the core assembly includes a test assembly, which includes a test switch coupled to the control circuit board and a test button attached to the test switch, where the test button is exposed outside the shell.

18. The leakage protection device of claim 2, wherein the leakage protection device is a power plug, wherein the input-end assembly includes at least a pair of plug prongs extending out of the shell, wherein the temperature sensor is disposed on an inner wall of the shell and between the pair of plug prongs or adjacent to each plug prong.

19. The leakage protection device of claim 18, wherein the actuator assembly is configured to disconnect the input-end assembly and the output-end assembly from each other based on a temperature detected by the temperature sensor exceeding a preset parameter, and to prevent the input-end assembly and the output-end assembly from being re-connected before the input-end assembly is disconnected from the input power supply so that the output-end assembly has no power output, and wherein after the input-end assembly is disconnected from the input power supply and then re-connected to the input power supply, the input-end assembly and the output-end assembly are re-connected by reset.

20. The leakage protection device of claim 1, wherein the actuator assembly is configured to disconnect the input-end assembly and the output-end assembly from each other based on at least one electrical parameter detected by the fault detection assembly exceeding a corresponding preset parameter, wherein the control circuit board is configured to prevent the input-end assembly and the output-end assembly from being re-connected before the input-end assembly is disconnected from the input power supply so that the output-end assembly has no power output, and wherein after the input-end assembly is disconnected from the input power supply and then re-connected to the input power supply, the input-end assembly and the output-end assembly are re-connected by reset.

21. The leakage protection device of claim 1, wherein the shell includes an upper shell and a lower shell attached to each other, the lower shell including a first lower shell portion and a second lower shell portion attached to each other, and wherein the leakage protection device further comprises least one scaling member disposed between the upper shell and the lower shell and/or between the first lower shell portion and the second lower shell portion.
